(19) United States
(12) Patent Application Publication
(10) Pub. No.: US 2005/0105862 A1
(43) Pub. Date: May 19, 2005

(54) Laser module package and method of manufacturing the same

(76) Inventors: Ki Suk Sung, KyoungKido (KR); Jae Chun Yun, KyungKido (KR); Tae Woo Yun, KyoungKido (KR)

Correspondence Address: BIRCH STEWART KOLASCH & BIRCH, PO BOX 747, FALLS CHURCH, VA, 22040-0747, US

(21) Appl. No.: 10/787,186

(22) Filed: Feb. 27, 2004

(30) Foreign Application Priority Data
May 28, 2003 (KR) 10-2003-33960

(51) Int. Cl. G02B 6/26

(52) U.S. Cl. 385/93

(57) ABSTRACT

Disclosed herein is a laser module package and method of manufacturing the laser module package. In the present invention, the optical structure of the laser module package is provided so that a conventional laser diode can be easily coupled to an optical fiber by employing an additional lens (correction lens) behind the laser module. Furthermore, an adjustment device for easily moving the additional lens along an optical axis is employed so that parallel light can be output from the additional lens by utilizing the additional lens and the adjustment device in conjunction with the laser diode from which parallel light is not output.

### BACKGROUND OF THE INVENTION

1. Field of the Invention

The present invention relates generally to a laser module package and method of manufacturing the laser module package.

2. Description of the Related Art

A laser diode used for communications is an electro-optic device for converting electric energy into optical energy. To use the laser diode in communications, an optical output from the laser diode should be transmitted to an optical fiber. If the laser diode is coupled to the optical fiber without using any transmission medium, only an extremely small part of light radiated from the laser diode is transmitted to the optical fiber, so that the efficiency of transmission is reduced. Accordingly, to increase coupling efficiency between the laser diode and the optical fiber, an appropriate transmission medium is required. For such a transmission medium, a lens interposed between the laser diode and the optical fiber has been used.

As shown in FIG. 1, a laser diode 1 and a lens 2 are fabricated into a single laser module and the single laser module is coupled to an optical fiber 4. The laser diode 1 and the optical fiber 4 are aligned so that the center of the end of the optical fiber 4 is located at a point 3 (focal point) on which the output light of the laser diode 1 is focused through the lens 2, thus transmitting the optical output of the laser diode 1 to the optical fiber 4. By horizontally and vertically moving the optical fiber 4, the optical fiber 4 is aligned so the focal point 3 on which the output light of the laser diode 1 is focused through the lens 2 is set at the center of the end surface of the optical fiber 4.

When the laser module is sealed with a flat cover glass, the lens is attached to the rear end of the flat cover glass and the laser module is coupled to the optical fiber in the same way as described above.

However, if light radiated from the laser diode 1 is focused through the lens 2 when such a scheme is applied, the diameter of a light beam in the optical fiber 4 is about several to 10 μm. Accordingly, even when the focal point 3 of the light is slightly offset from the central axis of the optical fiber 4 (about 0.5 μm in FIG. 2), the amount of light transmitted to the optical fiber 4 is considerably reduced compared with the original amount of light. In other words, if the scheme of FIG. 1 is employed, an optical output sensitively varies with the extent to which the focal point 3 of the light beam is offset from the center of the optical fiber 4, so that the tolerance of the laser module package is relatively small, thus resulting in the difficult manufacturing of the laser module package, the lower uniformity of manufacturing and the lower yield of manufacturing.

In order to overcome the problems of the method of FIG. 1, a technology employing the method of FIG. 3 has been developed and utilized.

In this method, a laser diode 5 and a first lens 6 are manufactured into a single laser module to produce parallel light, a collimator is manufactured in advance to allow an optical fiber 9 to be placed at the focal point of a second lens 8, and the laser module 7 and the collimator 10 are aligned with each other. In the method of FIG. 3, the diameter of light output from the first lens 6 is about 400 to 600 μm, which is several tens times compared with several to 10 μm that is the diameter of light at the focal point 3 of FIG. 1. Accordingly, it is easy to align and fix the laser module 7 and the collimator 10, so that the output of a laser module package is not considerably reduced due to the large tolerance of assembly even if the alignment of component parts is slightly incorrect, thus increasing the yield of manufacturing and allowing products of uniform performance to be manufactured.

However, the method of manufacturing the laser module 7 and the collimator 10 in advance and aligning them, which is shown in FIG. 3, can be implemented only if the laser module 7 is accurately manufactured to output parallel light. In practice, it is difficult to apply the method of FIG. 3 because there are many cases where the output of the laser module 7 is not parallel light due to the below-described problems.

The problems are described in detail with reference to FIG. 5 below.

The laser module 7 actually has a structure shown in FIG. 5. As shown in FIG. 5, a laser diode 11 is mounted while being fastened to a support 12, and a lens 13 is fastened to a metallic casing 14. To allow light radiated from the laser diode 11 to form parallel light after passing through the lens 13, the laser diode 11 must be spaced apart from the lens 13 by a distance corresponding to a focal distance f that is determined depending upon the lens 13. Furthermore, to manufacture the laser module 7, the lens 13 must be sealed in and fastened to the metallic casing 14, and the casing 14 with the lens 13 fastened thereto must be welded to a base 16 at a location 15.

Additionally, since any organic material or epoxy must not exist in a sealed space 17 in which the laser diode 11 is contained, the metallic casing 14 with the lens 13 attached thereto must be welded to the base 16 at the location 15 after the lens 13 is sealed in and fastened to the metallic casing 14 through glass sealing or the like in advance.

However, it is difficult to accurately manufacture the casing 14. Even though the casing 14 is manufactured to be so accurate that the laser diode 11 is spaced apart from the lens 13 by the focal distance f, it is difficult to control the location where the laser diode 11 is attached to the support 12, the welded portion of the casing 14 is melted while the casing 14 with the lens 13 attached thereto is welded to the base 16 and the extent to which the welded portion of the casing 14 is melted is difficult to control, so that it is difficult to make the spaced distance coincide with the focal distance f. Meanwhile, in the case where the spaced distance does not coincide with the focal distance f, the spaced distance must be corrected to coincide with the focal distance f by horizontally moving the lens 13. However, as described above, the lens 13 is sealed in and fastened to the casing 14 in advance, so that it is impossible to move the lens 13. As a result, since the laser module the spaced distance of which does not coincide with the focal distance f can not output parallel light, it is difficult to align the laser module 7 with an optical fiber and the output of the laser module package, thus resulting in low coupling efficiency and a reduction in the performance of products. For such a reason, most of laser module providers do not supply laser modules in which parallel light is output from lenses.

### SUMMARY OF THE INVENTION

Accordingly, the present invention has been made keeping in mind the above problems occurring in the prior art, and an object of the present invention is to provide a laser module package and method of manufacturing the laser module package, in which the optical structure of the laser module package is provided so that a conventional laser diode can be easily coupled to an optical fiber by employing an additional lens (correction lens) behind the laser module, and an adjustment device for easily moving the additional lens along an optical axis is employed so that parallel light can be output from the additional lens by utilizing the additional lens and the adjustment device in conjunction with the laser diode from which parallel light is not output.

In order to accomplish the above object, the present invention provides a laser module package, including a laser module comprising a laser diode for converting an electrical signal into light, a first lens for focusing the light output from the laser diode, and a casing for sealing and fastening the first lens and surrounding and sealing the laser diode; a correction lens placed behind the first lens for outputting parallel light; a second lens for focusing the parallel light output from the correction lens; and an optical fiber fixed so that a center of an end thereof is positioned at a location where the light output from the second lens is focused.

In addition, the present invention provides a method of manufacturing a laser module package, including the steps of placing a laser module comprised of a laser diode for converting an electrical signal into light, a first lens for focusing the light output from the laser diode, and a casing for sealing and fastening the first lens and surrounding and sealing the laser diode; locating a correction lens behind the first lens for outputting parallel light; positioning a second lens to focus the parallel light output from the correction lens; and fixing an optical fiber so that a center of an end of the optical fiber is positioned at a location where the light output from the second lens is focused.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a schematic diagram showing the optical structure of a conventional laser module package;

FIG. 2 is a graph showing the assignment characteristic curves of the laser module package of FIG. 1;

FIG. 3 is a schematic diagram showing the optical structure of another conventional laser module package;

FIG. 4 is a graph showing the assignment characteristic curves of the laser module package of FIG. 3;

FIG. 5 is a view showing the structure of a typical laser module;

FIG. 6 is a view showing the optical structure of a laser module package in accordance with the present invention; and

FIG. 7 is a view showing a laser module package with an adjustment device equipped therewith in accordance with the present invention.

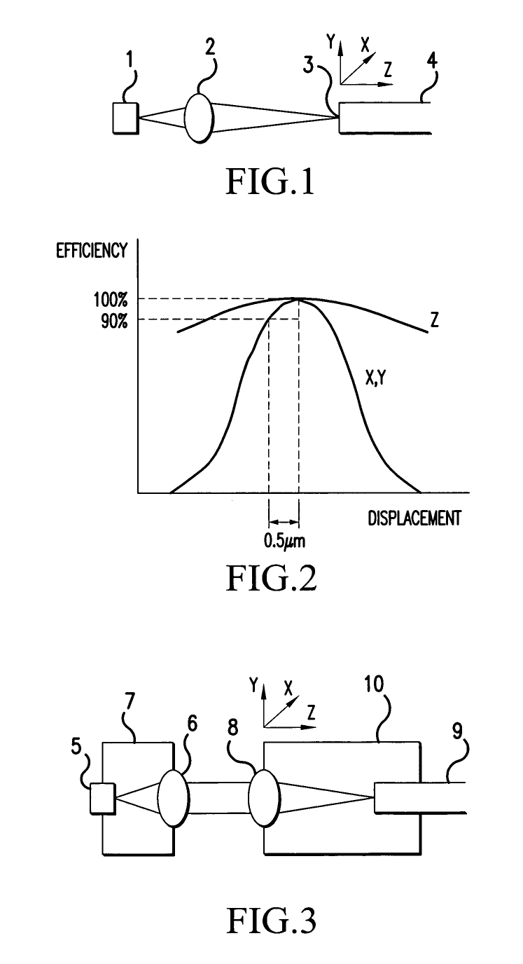

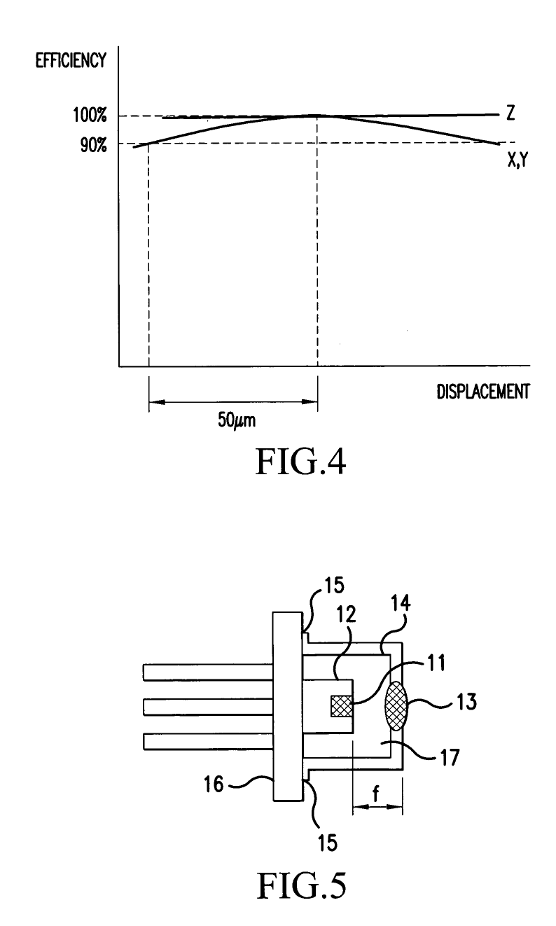

### DESCRIPTION OF THE PREFERRED EMBODIMENTS

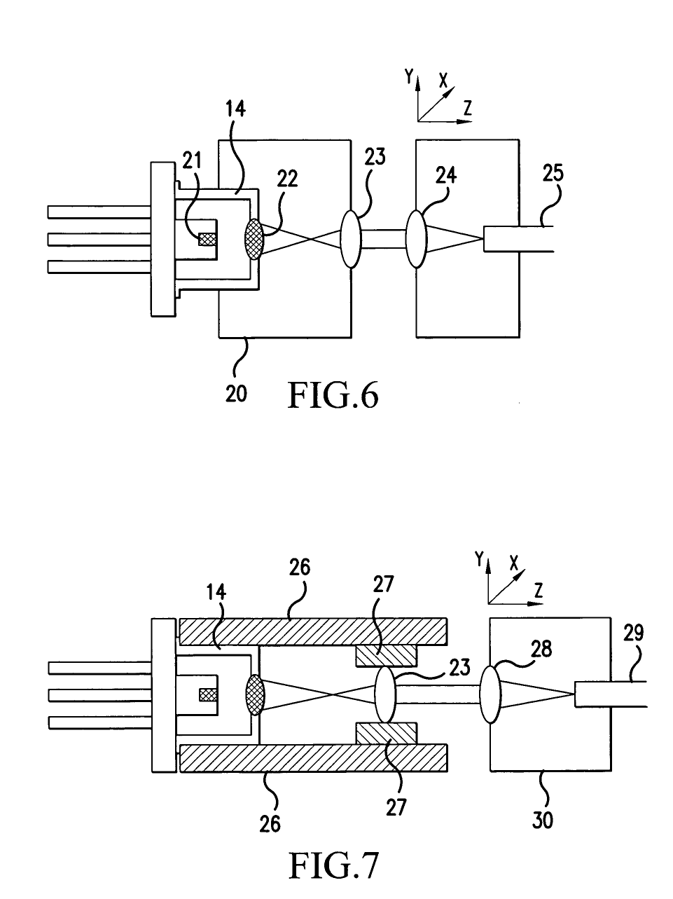

An optical structure according to the present invention is described with reference to FIG. 6.

In the case of a conventional laser module 20, it is difficult to make the distance between a diode 21 and a first lens 22 coincide with the focal distance f of the first lens 22, so that it is difficult to allow light output from the first lens 22 to be parallel light.

However, as shown in FIG. 6, if a correction lens 23 is fixed at a location where light output from the correction lens 23 are made parallel by placing the correction lens 23 at the rear end of the laser module 20 and adjusting the distance between the first lens 22 and the correction lens 23, it is possible to easily correct even the laser module 20 which is designed to output focused light, to output parallel light. When such a correction is made to allow parallel light to be output from the correction lens 23 as described above, a laser module package of the present invention can be obtained by aligning the laser module 20, a second lens 24 and an optical fiber 25.

Accordingly, utilizing the present invention, it is not necessary to accurately fabricate a casing 14, accurately attach the laser diode 21 to a support 12, and accurately weld the casing 14, so that the manufacturing of the laser module package is considerably facilitated, thus significantly increasing the yield of manufacturing.

A preferred embodiment of an adjustment device for easily adjusting the distance between the first lens 22 and the collection lens 23 in the optical structure described in conjunction with FIG. 6 is described with reference to FIG. 7 below.

A guide tube 26 is placed so that one end thereof is secured to the casing 14 while surrounding the casing 14, and the other end thereof is oppositely extended from the casing 14. A sliding member 27, as shown in FIG. 7, is located in the guide tube 26 to slide along the guide tube 26. The correction lens 23 is tightly fitted into the sliding member 27. In this case, the correction lens 23 is fitted into the sliding member in advance, and the slide member 27 with the correction lens 23 fitted therein is horizontally moved along the guide tube 26 using a high-precision device, such as a stage.

When a user, as shown in FIG. 7, observes parallel light while moving the sliding member 27 along the guide tube 26 and observing light output from the correction lens 23 using a measurement device, such as a beam master, the sliding member 27 is fastened to the guide tube 26 at a location where the parallel light is observed, through welding, soldering or the application of an epoxy.

Thereafter, by assembling a collimator 30 so that the front end of the optical fiber 29 is located at the focal point of the second lens 28 in advance and aligning the collimator 30 with parallel light output using the adjustment device of the present invention for allowing parallel light to be output, a desired laser module package can be obtained.

In brief, with the adjustment device of the present invention, focused light can be significantly easily corrected into parallel light even though the focused light is output from the laser module 20, as shown in FIG. 3. In other words, when even the laser module 20 designed to output focused light is adjusted using the inexpensive sliding member 27 with the correction lens 23 fitted thereinto and the inexpensive guide tube 26 so that parallel light can be output from the correction lens 23, the performance of the laser module and the yield of manufacturing can be improved, and thus reducing the price of the product.

Although the preferred embodiments of the present invention have been disclosed for illustrative purposes, the present invention is not limited to the embodiments, but various modifications, additions and substitutions are possible without departing from the scope and spirit of the invention as disclosed in the accompanying claims.

For example, although the optical structure and adjustment device of the present invention disclosed in FIGS. 6 and 7, respectively, have been described as being applied to the structure in which the lens 13 is attached to the casing 14, as shown in FIG. 5, the present invention can be applied to a laser module structure in which a flat cover glass instead of the lens 13 of FIG. 5 is employed and a lens is employed at the rear end of the structure.

Meanwhile, if one or more optical isolators are employed between the first lens 22 and the correction lens 23 and/or between the correction lens 23 and the second lens 24, light output from the laser diode and reflected by an optical fiber can be prevented from returning to the laser diode.

In accordance with the present invention, even the laser module from which focused light is output can be easily corrected to output parallel light. Accordingly, when the laser module is coupled to the optical fiber, the tolerance of the laser module package is increased, so that the assembly of the laser module package is facilitated and the yield of manufacturing of such packages is significantly increased.

1. A laser module package, comprising:
a laser module comprising a laser diode for converting an electrical signal into light, a first lens for focusing the light output from the laser diode, and a casing for sealing and fastening the first lens and surrounding and sealing the laser diode;
a correction lens placed behind the first lens for outputting parallel light;
a second lens for focusing the parallel light output from the correction lens; and
an optical fiber fixed so that a center of an end thereof is positioned at a location where the light output from the second lens is focused.

2. A laser module package, comprising:
a laser module comprising a laser diode for converting an electrical signal into light, a flat cover glass for passing the light output from the laser diode therethrough, a first lens for focusing light output from the flat cover glass, and a casing for sealing and fastening the flat cover glass and surrounding and sealing the laser diode;
a correction lens placed behind the first lens for outputting parallel light;
a second lens for focusing the parallel light output from the correction lens; and
an optical fiber fixed so that a center of an end thereof is positioned at a location where the light output from the second lens is focused.

3. The laser module package as set forth in claim 1 or 2, wherein the correction lens is sealed in and fastened to a sliding member that is movable along a guide tube extending while surrounding the laser module.

4. The laser module package as set forth in claim 3, wherein the sliding member is fastened to the guide tube at a location where the parallel light can be output from the correction lens.

5. The laser module package as set forth in claim 1 or 2, further comprising an optical isolator placed between the first lens and the correction lens.

6. The laser module package as set forth in claim 1 or 2, further comprising an optical isolator placed between the correction lens and the second lens.

7. A method of manufacturing a laser module package, comprising the steps of:
placing a laser module comprised of a laser diode for converting an electrical signal into light, a first lens for focusing the light output from the laser diode, and a casing for sealing and fastening the first lens and surrounding and sealing the laser diode;
locating a correction lens behind the first lens for outputting parallel light;
positioning a second lens to focus the parallel light output from the correction lens; and
fixing an optical fiber so that a center of an end of the optical fiber is positioned at a location where the light output from the second lens is focused.

8. A method of manufacturing a laser module package, comprising:
placing a laser module comprised of a laser diode for converting an electrical signal into light, a flat cover glass for passing the light output from the laser diode therethrough, a first lens for focusing light output from the flat cover glass, and a casing for sealing and fastening the flat cover glass and surrounding and sealing the laser diode;
locating a correction lens placed behind the first lens for outputting parallel light;
positioning a second lens to focus the parallel light output from the correction lens; and
fixing an optical fiber so that a center of an end of the optical fiber is positioned at a location where the light output from the second lens is focused.

9. The method as set forth in claim 7 or 8, wherein the correction lens is sealed in and fastened to a sliding member that is movable along a guide tube extending while surrounding the laser module.

10. The method as set forth in claim 9, wherein the sliding member is fastened to the guide tube at a location where the parallel light can be output from the correction lens.

11. The method as set forth in claim 7 or 8, further comprising an optical isolator placed between the first lens and the correction lens.

12. The method as set forth in claim 7 or 8, further comprising an optical isolator placed between the correction lens and the second lens.
